(19) United States
(12) Patent Application Publication
(10) Pub. No.: US 2022/0353341 A1
(43) Pub. Date: Nov. 3, 2022

(54) EFFICIENT DEPLOYMENT OF CLOUD RESOURCES

(71) Applicant: Attini Cloud Solutions International AB, Stockholm (SE)

(72) Inventors: Carl Olov ÖSTRAND, Stockholm (SE); Oscar Olov ÖSTRAND, Stockholm (SE)

(21) Appl. No.: 17/688,111

(22) Filed: Mar. 7, 2022

Related U.S. Application Data
(60) Provisional application No. 63/180,943, filed on Apr. 28, 2021.

(51) Int. Cl. H04L 67/00; H04L 67/51; H04L 67/1097

(52) U.S. Cl. CPC H04L 67/34; H04L 67/16; H04L 67/1097

(57) ABSTRACT

There is provided a method and corresponding system, cloud compute unit and computer program for enabling and/or performing deployment of cloud resources. More specifically, the method comprises downloading and/or receiving a package of files and/or a packed file archive including a number of files from an identifiable storage location, unpacking the files, and identifying and/or finding an Infrastructure as Code (IaC) file collection, including one or more code and/or configuration files, in the file archive or among the unpacked files. Further, the method comprises deploying the IaC code and/or configuration files to enable and/or effectuate physical implementation and/or configuration of cloud resources as specified by the IaC code and/or configuration files.

### TECHNICAL FIELD

The invention generally relates to the technical field of cloud systems and cloud computing, and more particularly to a method for enabling and/or performing cloud deployment, a corresponding cloud deployment system and a cloud compute unit, as well as corresponding computer programs and computer-program products.

### BACKGROUND

The term cloud was early used as a metaphor for the Internet and a standardized cloud-like shape was used to denote a network on telephony schematics in the early 1990's. The term cloud was used to refer to platforms for distributed computing as early as 1993.

Nowadays, cloud systems and cloud computing are everywhere. Cloud computing may be defined as the on-demand availability of computer resources, especially data storage (cloud storage) and computing power, without direct active management by the user. The term is sometimes used to describe data centers available to many users over the Internet. Large clouds, predominant today, often have functions distributed over multiple locations from central servers. If the connection to the user is relatively close, it may sometimes be referred to as an edge server.

There are many solutions for deploying cloud resources such as Information Technology (IT) infrastructure, networks, network components (like gateways and routers), virtual machines, databases and so forth. However, as cloud deployments become more and more complex, there is a general need for improved and/or automated cloud deployment solutions, e.g. a standardized way of configuring and managing a general cloud system.

Currently, there are a number of conventional solutions for deploying cloud resources. Some of these solutions attempt to automate the deploys, but these solutions fail to meet the needs of the industry because they are acting from a central IT environment such as a build server or management system. This leads to tight dependencies between companies' IT management resources (build servers, configuration servers, deployment SaaS solutions etc.) and the applications they manage. This makes the IT environments harder to secure, harder to manage, hard to scale and less fault tolerant.

Other solutions attempt to distribute the deploy to avoid these tight dependencies, but these solutions are similarly unable to meet the needs of the industry because they are “always alive” cloud compute resources that always cost money. The operating system and the application on it will also have to be maintained (patched). If they are not maintained they can cause availability and security issues.

US 2021/0042096 relates to methods, apparatuses/systems, and media for providing Infrastructure as Code (IaC) templates in a cloud environment, where a processor creates a plurality of IaC templates. Each of the plurality of IaC templates includes instructions to build at least a portion of an infrastructure.

U.S. Pat. No. 10,872,029 relates to a system, apparatus and method to provision and deploy a software application for operation as a resource operating on a cloud computing network accessible to a plurality of users.

U.S. Pat. No. 10,791,021 relates to technologies for storage and retrieval of parameters used in the creation and editing of IaC templates.

U.S. Pat. No. 10,747,650 relates to systems and methods for on-demand container-based development environments.

US 2020/0387357 relates to techniques, systems, and devices for implementing a system that uses machine generated infrastructure code for software development and infrastructure operations, allowing automated deployment and maintenance of a complete set of infrastructure components.

### SUMMARY

It is a general object to enable improved cloud deployment of cloud resources.

It is a specific object to provide a method for enabling and/or performing cloud deployment.

Another object is to provide a corresponding cloud deployment system.

It is also an object to provide a cloud compute unit configured to enable efficient cloud deployment.

Still another object is to provide a corresponding computer program and computer-program product.

According to a first aspect, there is provided a method for enabling and/or performing deployment of cloud resources. The method comprises:
downloading and/or receiving a package of files and/or a packed file archive including a number of files from an identifiable storage location,
unpacking the files,
identifying and/or finding an Infrastructure as Code (IaC) file collection, including one or more code and/or configuration files, in the file archive or among the unpacked files; and
deploying the IaC code and/or configuration files to enable and/or effectuate physical implementation and/or configuration of cloud resources as specified by the IaC code and/or configuration files.

According to a second aspect, there is provided a cloud deployment system for deployment of cloud resources. The cloud deployment system is configured to download and/or receive a package of files and/or a packed file archive including a number of files from an identifiable storage location, and to unpack the files. The cloud deployment system is also configured to identify and/or find an Infrastructure as Code (IaC) file collection, including one or more code and/or configuration files, in the file archive or among the unpacked files. The cloud deployment system is further configured to deploy the IaC code and/or configuration files to enable and/or effectuate physical implementation and/or configuration of cloud resources as specified by the IaC code and/or configuration files.

According to a third aspect, there is provided a cloud compute unit configured to enable deployment of cloud resources. The cloud compute unit is configured to download and/or receive a package of files and/or a packed file archive including a number of code and/or configuration files from an identifiable storage location. The cloud compute unit is configured to unpack the files. The cloud compute unit is also configured to identify and/or find an Infrastructure as Code (IaC) file collection, including one or more code and/or configuration files, in the file archive or among the unpacked files. Further, the cloud compute unit is configured to deploy the IaC code and/or configuration files to enable and/or effectuate physical implementation and/or configuration of cloud resources as specified by the IaC code and/or configuration files.

According to a fourth aspect, there is provided a computer program and associated computer-program product for performing, when executed by a processor, the method for enabling and/or performing cloud deployment according to the first aspect.

In this way, the proposed technology enables efficient cloud deployment. This process and/or architecture allows relevant units within a cloud system to automate complex cloud deployments in a secure, repeatable and fault-tolerant manner.

Other advantages of the invention will be appreciated when reading the below detailed description.

### BRIEF DESCRIPTION OF THE DRAWINGS

The invention, together with further objects and advantages thereof, may best be understood by making reference to the following description taken together with the accompanying drawings, in which:

FIG. 1 is a schematic diagram illustrating an example of a use case in a general cloud environment, including a non-limiting example of an improved procedure and/or configuration for enabling and/or performing efficient cloud deployment.

FIG. 2 is a schematic diagram illustrating another example of a use case in a general cloud environment, including an alternative non-limiting example of an improved procedure and/or configuration for enabling and/or performing efficient cloud deployment.

FIG. 3 is a schematic flow diagram illustrating an example of a method for enabling and/or performing cloud deployment.

FIG. 4 is a schematic diagram illustrating an example of a cloud compute unit for enabling cloud deployment.

FIG. 5 is a schematic diagram illustrating an example of a computer implementation according to an embodiment.

### DETAILED DESCRIPTION

Throughout the drawings, the same reference numbers are used for similar or corresponding elements.

As mentioned, there is a general need for improved and/or automated cloud deployment solutions, e.g. a standardized way of at least partly configuring and managing a general cloud system.

The proposed technology may be regarded as a deployment framework for IT Infrastructure as Code (IaC).

By way of example, the proposed technology relates to both a system and associated software. The system may be seen as a deployment system in the cloud. For example, core components may include system code and cloud compute resources with a dependency on cloud storage such as a cloud object storage and an IaC file collection (such as an IaC template) of one or more IaC code and/or configuration files. These components may be structured in such a way so as to define a standardized way of configuring and managing any cloud IT environment.

Preferably, the architecture allows the system to automate complex cloud deployments in a secure, repeatable and fault tolerant manner. In order to accomplish desired objectives, the system may employ associated software that automates deployment tasks that triggers the initiation deployment and lays the foundation for any type of cloud deployment to happen later in the deploy process. The software manages files (e.g. code and configuration files) and initiates a cloud deployment that allows a standardized and automated way of working with cloud IT environments.

For a better understanding, it may be useful to provide some additional non-limiting explanations and/or definitions of certain terms and concepts within cloud systems and cloud deployment:

Cloud provider: Public cloud provider that provides IaaS (Infrastructure as a Service), PaaS (Platform as a Service) and SaaS (Software as a Service) offerings and/or underlying technology platforms. Example of cloud providers are AWS (Amazon Web Services), GCP (Google Cloud Platform) and Microsoft Azure.

Cloud resources: A collective name for the systems, components and/or services (such as IaaS, PaaS and SaaS) offered by the Cloud Providers or their partners. From a technological point of view, cloud resources may include IT infrastructure, networks, network components (like gateways and routers), computing and/or processing resources, virtual machines, databases and so forth.

Cloud storage: A cloud provider service/system for storage. This could for example include cloud block storage or cloud object storage.

Cloud block storage: A cloud provider PaaS service/system for storage. Examples of cloud block storage are AWS Elastic Block Storage (EBS), GCP Disk, Azure Disk Storage, AWS Elastic File system (EFS), Google Cloud Filestore or Azure Files. Cloud block storage can be mounted by a cloud compute service (with an operating system like Linux) as a file system.

Cloud object storage: A cloud provider PaaS service/system that allows users and applications to save/manage files in the cloud using a network protocol, for example HTTPS, so that users can integrate with the files using the normal Web API calls. These API calls are often simplified/abstracted using the cloud providers CLI (command line interface) and SDK (system development kit). An object storage should not be confused with a SFTP service, Block storage or a file system. The big difference between these technologies and an object storage is that an Object storage does not need an OS (operating system) to mount the storage. Cloud object storage often has event hooks/triggers, which the architecture of the proposed technology uses to initiate the cloud compute. In the future, similar hooks/triggers may be built and defined also for cloud block storage. Examples of Objects storages are Amazon S3, GCP Cloud Storage and Azure Blob Storage.

Infrastructure as Code (IaC): A technology that allows IT professionals to use software to define what cloud providers services/systems to be created (configured) and optionally how they should updated (and sometimes deleted). Examples of Infrastructure as Code is AWS Cloudformation, Hashicorp Terraform, Azure Resource Manager (ARM), Pulumi and GCP Deployment Manager. This can be seen as cloud service formation and/or deployment.

IaC template: The collective word for the IaC software files i.e., the IaC code. Templates can sometimes be one code file, but it can also be a collection of code and/or configuration files in a directory.

Cloud compute unit: A unit or system that can execute program code, like a virtual machine, a container (example docker), a cloud function (AWS Lambda, GCP Cloud functions, Azure Functions) or any other processing unit or code execution system. This can be any entity enabling code execution.

IaC Deploy: The initiation of a cloud deployment based on IaC code file(s) or the IaC template. An API call that creates or updates cloud resources from an IaC template.

IaC Stack: The instantiation of an IaC template. The IaC deploy creates an IaC Stack from the template and its configuration. An IaC Stack first creates all cloud resources as they are defined in the template. The IaC stack later keeps track of its cloud resources so if the template is updated and re-deployed the underlying cloud resources will be updated. This term is sometimes referred to as a state file or a state stack for maintaining and/or updating the state of the cloud deployment/infrastructure.

Entity: User or systems that can perform actions on the system.

Hack: When an entity manipulates a system to do something unintended by the system's creator. This is often done in order to attack the system with malicious intent.

File archive: A packed collection of digital files. Examples of file archives include zip, tar, pax and rar archives.

Dormant: In this context dormant refers to a cloud service that only costs money when it's actively used. Meaning that the availability (ability to interact with the service) is provided for free (or to a low or insignificant cost) by the cloud provider and only active usage costs money. Examples of dormant cloud services are AWS SQS, AWS API Gateway, AWS DynamoDB (on-demand), GCP Pub/Sub, Azure Queue storage, AWS Lambda, GCP Cloud functions and Azure Functions.

API: The acronym for Application Programming Interface. The application in this case is any type of dormant cloud technology that can expose an interface. Calling the API invokes/triggers the system.

It would be desirable to have a standardized architecture with associated software that automates cloud deployments. These deployments should be flexible, secure and fast while keeping redundant copies of all required files so that it has as few external dependencies as possible.

Furthermore, it would also be desirable to have a system and software that allows for tests in a structured manner. The disclosed system and associated software advantageously fulfill at least part of these needs and address at least part of the aforementioned deficiencies by providing a standardized way of packaging files (e.g. code and configuration files) and deploying them to cloud environments, e.g. in a distributed, versioned, and predictable way.

To start with, the proposed technology will be described on a general level followed by various, different exemplifying embodiments, and later on a disclosure of a number of non-limiting examples.

According to a first aspect, there is provided a method for enabling and/or performing deployment of cloud resources. Basically, the method comprises:
downloading and/or receiving a package of files and/or a packed file archive including a number of files from an identifiable storage location,
unpacking the files,
identifying and/or finding an Infrastructure as Code (IaC) file collection, including one or more code and/or configuration files, in the file archive or among the unpacked files; and
deploying the IaC code and/or configuration files to enable and/or effectuate physical implementation and/or configuration of cloud resources as specified by the IaC code and/or configuration files.

In other words, the proposed technology can be seen as a method and corresponding system for deploying cloud resources and/or for enabling such deployment. For example, this may relate to provisioning and deploying of hardware, software and/or combinations thereof for operation as one or more resources operating on a cloud computing network accessible to one or more users.

Optionally, the method further comprises uploading and/or transferring the unpacked files to cloud storage.

By way of example, the IaC file collection, including one or more code and/or configuration files, may be represented by one or more files of an IaC template.

For example, the package of files and/or the packed file archive may be and/or include at least one of a zip, tar, pax and rar archive.

In a particular example, the step of downloading and/or receiving a package of files and/or a packed file archive is triggered by placement of the package of files and/or the packed file archive in cloud storage.

Alternatively, the step of downloading and/or receiving a package of files and/or a packed file archive may be triggered by an Application Programming Interface (API) call with an indication or instructions on where to find the package of files and/or the packed file archive.

In a particular example, the step of identifying and/or finding an Infrastructure as Code (IaC) file collection (at least partly) includes identifying and/or finding an indication of a location of the IaC file collection in the file archive or among the unpacked files.

As an example, the package of files and/or the packed file archive may be downloaded and/or received from a cloud storage or an alternative storage location that is accessible by a cloud compute unit.

Optionally, the step of deploying the IaC code and/or configuration files includes performing one or more well-accepted standard IaC deployment procedures, e.g., based on AWS Cloudformation, Hashicorp Terraform, Azure Resource Manager (ARM), Pulumi and/or GCP Deployment Manager.

By way of example, the deployment of the IaC file(s) may be configured to create and/or update an IaC stack or equivalent state holder for holding the current states of the cloud deployment, allowing the IaC stack to deploy any of a number of cloud resources.

Non-limiting examples of cloud resources include IaaS (Infrastructure as a Service), PaaS (Platform as a Service) and SaaS (Software as a Service) systems, components and/or services.

Expressed slightly differently, the cloud resources may include at least one of the following: IT infrastructure, networks or sub-networks, network components, gateways and routers, virtual machines, databases, and computing and/or processing resources.

Optionally, the method may further comprise at least one of the following:
adding a name, id and/or custom metadata in the package of files and/or the file archive;
adding configuration to the IaC file collection;
adding at least one file to the package of files and/or the file archive so that they will be unpacked and placed in the cloud storage.

In a preferred example, the method may be performed by a cloud compute unit.

According to a second aspect, there is provided a cloud deployment system configured for deployment of cloud resources.

The cloud deployment system may be configured to download and/or receive a package of files and/or a packed file archive including a number of files from an identifiable storage location, and to unpack the files.

The cloud deployment system may also be configured to identify and/or find an Infrastructure as Code (IaC) file collection, including one or more code and/or configuration files, in the file archive or among the unpacked files.

The cloud deployment system may further be configured to deploy the IaC code and/or configuration files to enable and/or effectuate physical implementation and/or configuration of cloud resources as specified by the IaC code and/or configuration files.

Optionally, the cloud deployment system is further configured to upload and/or transfer the unpacked files to cloud storage.

By way of example, the IaC file collection, including one or more code and/or configuration files, may be represented by one or more files of an IaC template. For example, the package of files and/or the packed file archive may be and/or include at least one of a zip, tar, pax and rar archive.

In a particular example, the cloud deployment system is configured to download and/or receive a package of files and/or a packed file archive in response to placement of the package of files and/or the packed file archive in cloud storage.

Alternatively, the cloud deployment system is configured to download and/or receive a package of files and/or a packed file archive in response to an Application Programming Interface (API) call with an indication or instructions on where to find the package of files and/or the packed file archive.

As an example, the cloud deployment system may be configured to identify and/or find an Infrastructure as Code (IaC) file collection by at least partly identifying and/or finding an indication of a location of the IaC file collection in the file archive or among the unpacked files.

In a particular example, the cloud deployment system may be configured to download and/or receive the package of files and/or the packed file archive from a cloud storage or an alternative storage location that is accessible by a cloud compute unit.

By way of non-limiting examples, the cloud resources may include at least one of the following: IT infrastructure, networks or sub-networks, network components, gateways and routers, virtual machines, databases, and computing and/or processing resources.

In a particular example, the cloud deployment system includes at least one processor configured to perform and/or enable said deployment of cloud resources. It should be understood that the processor(s) may be configured for operation with memory comprising software, which when executed by the processor(s) causes the cloud deployment system to perform and/or enable the deployment of cloud resources.

According to a third aspect, there is provided a cloud compute unit configured to enable deployment of cloud resources.

The cloud compute unit may be configured to download and/or receive a package of files and/or a packed file archive including a number of code and/or configuration files from an identifiable storage location.

The cloud compute unit may be configured to unpack the files.

The cloud compute unit may be configured to identify and/or find an Infrastructure as Code (IaC) file collection, including one or more code and/or configuration files, in the file archive or among the unpacked files.

The cloud compute unit may also be configured to deploy the IaC code and/or configuration files to enable and/or effectuate physical implementation and/or configuration of cloud resources as specified by the IaC code and/or configuration files.

Optionally, the cloud compute unit is further configured to upload and/or transfer the unpacked files to cloud storage.

By way of example, the cloud compute unit may include one or more processors configured to enable said deployment of cloud resources.

This disclosure will now provide a more detailed and specific description that will refer to the accompanying drawings. The drawings and specific descriptions of the drawings, as well as any specific or alternative embodiments discussed, primarily relate to non-limiting examples and are intended to be read in conjunction with the entirety of this disclosure. The deployment framework for IT infrastructure as code may, however, be embodied in many different forms and should not be construed as being limited to the embodiments set forth herein. Rather, these embodiments are provided by way of illustration only and so that this disclosure will be thorough, complete and fully convey understanding to those skilled in the art.

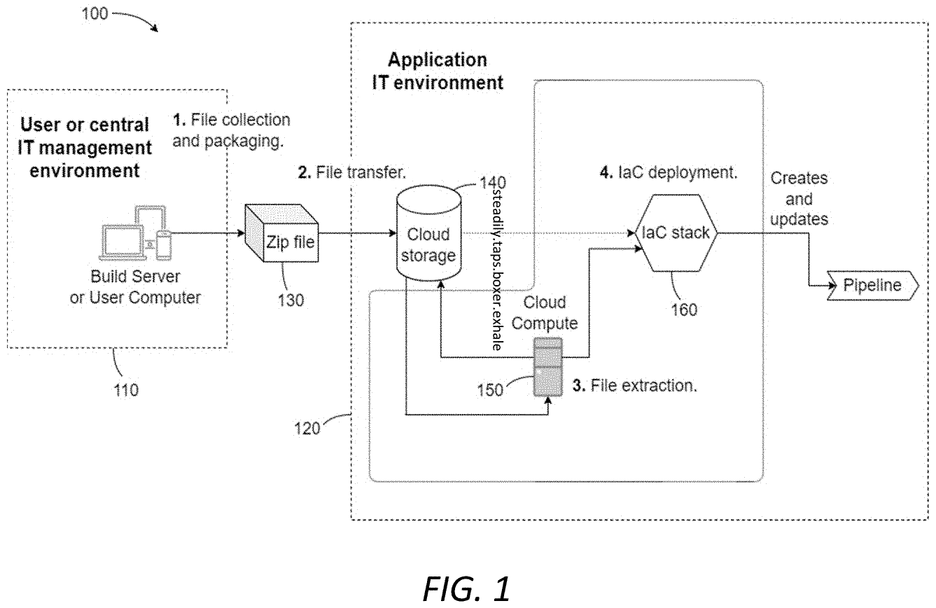

FIG. 1 is a schematic diagram illustrating an example of a user in a general cloud environment, including a non-limiting example of an improved procedure and/or configuration for enabling and/or performing efficient cloud deployment.

The overall system context 100 involves a user or central IT management environment 110 such as a build server or user computer, and an application IT environment 120, which in turn involves a cloud storage 140 such as a cloud object storage for receiving a package of files such as a packed file archive 130, e.g. a zip file, from the build server or user computer 110, a cloud compute unit 150 and an IaC stack 160 or equivalent function.

As part of the IT environment 120, there is a system for enabling and/or performing cloud deployment together with an associated computer process. The overall cloud deployment system is typically made up of the following components: the cloud compute unit and/or system 150 and associated system code with a dependency on cloud (object) storage, and an IaC template or equivalent IaC file collection.

By way of example, a file archive 130 such as a zip file is placed on cloud storage 140, that triggers the cloud compute unit 150 that runs the system code. The cloud compute unit 150 then deploys the IaC template from the file archive.

With reference to FIG. 1, the overall process may be schematically outlined as follows:

1. File collection and packaging.
2. File transfer.
3. File download/reception and file extraction.
4. IaC deployment.

By way of example, a user or central IT management system 110 such as a build server may collect the files for a particular deploy and package them in relevant form in a file archive 130 such as a zip file or equivalent file format. Optionally, the file archive 130 such as a zip file may then be placed in the cloud storage 140.

In this example, the cloud compute unit 150 may react to the new zip file (or more general file archive) in the cloud storage 140 by i) downloading the zip file, ii) extracting the zip file, iii) optionally putting the extracted files in the artifact storage, and iv) finding a template and configuration among the extracted files and deploy it. By way of example, action iv) may be performed before action iii) of optionally putting the extracted files back in the artifact storage. It should also be noted that the artifact storage could be the same as the original cloud storage or a different storage.

It can also be noted that IaC technology often require templates, configuration files or state files to be stored on a cloud object storage, but the actual deploy is performed or at least initiated by the cloud compute unit.

As exemplified here, the placement of the file archive in cloud storage 140 may trigger the cloud compute unit 150 to initiate deployment of the IaC template. An example of the associated computer process, e.g. performed by the cloud compute unit, can be summarized by the following executable steps:

i. Download/receive the file archive from cloud storage.
ii. Unpack or extract the file archive.
iii. Optionally, upload/transfer the unpacked files into cloud storage (this can be the same or a different storage unit).
iv. Identify/find an IaC template in the file archive or among the unpacked files and initiate deployment of the IaC template. This may at least partly happen before ii and iii.

It should be understood that the file archive does not necessarily have to include the IaC template, but it may alternatively include instructions or an indication as to where to find the IaC template.

In a particular example, the file archive is a zip file, which may be in compressed or uncompressed form. The files in the zip file are extracted or unpacked to enable the cloud compute unit to continue its work. It should be understood that other types of file archives may be used such as tar, pax and rar archives, in compressed or uncompressed form.

By way of example, the IaC stack 160 may be configured to create and maintain the cloud resources needed for a certain deploy. For more complex deploys, the IaC stack may be configured to create or invoke one or more resources, such as a well-accepted standard pipeline, that can carry out the rest of the actual deployment.

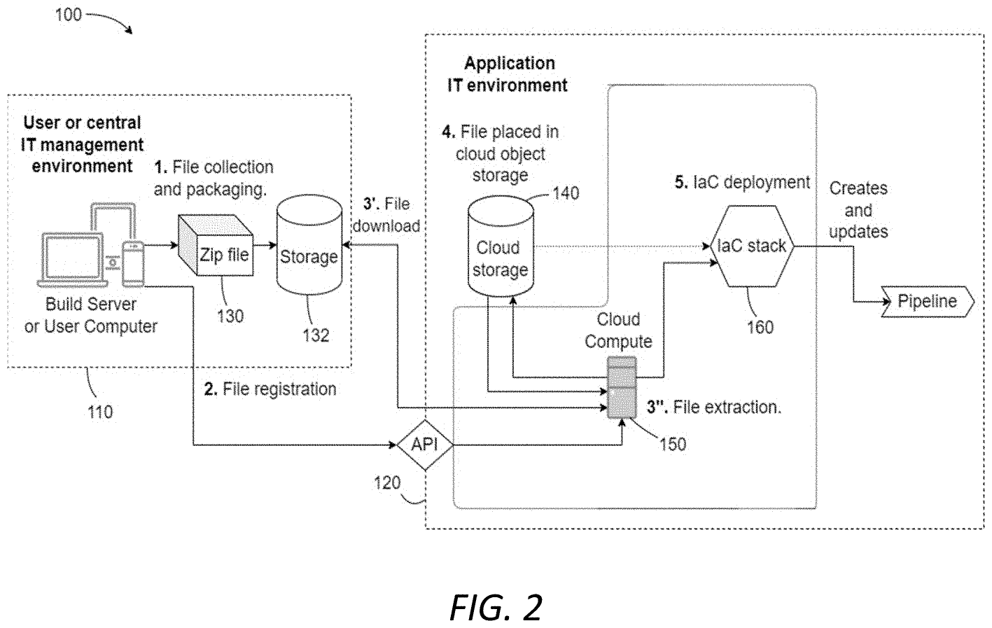

FIG. 2 is a schematic diagram illustrating another example of a use case in a general cloud environment, including an alternative non-limiting example of an improved procedure and/or configuration for enabling and/or performing efficient cloud deployment.

An alternative solution that will achieve the same overall result would be an API call that triggers the deploy with instructions for the cloud compute unit on where to fetch the file archive from. This architecture will decrease the dependency on object storage functionality and increase the authentication options making this a very likely architecture for implementation and/or commercialization of the technology.

In this alternative example, the file archive is not necessarily downloaded from cloud storage but rather from any identifiable storage location. This means that the user or central IT management system 110 stores the file archive 130 such as a zip file in any suitable storage location that is (at least temporarily) accessible by the cloud compute unit 150. The storage location may be a cloud storage (such as a cloud object storage or even possibly a cloud block storage) but in this case it may also be a local storage 132. By way of example, the user or central IT management system 110 may trigger the cloud compute unit 150, e.g. by means of an API call with an indication or instructions on where to find the file archive 130.

With reference to FIG. 2, the overall process may be schematically outlined as follows:

1. File collection and packaging.
2. File registration (and file transfer to selected storage).
3′. File download/reception
3″. File extraction.
4. Optional placement of file(s) in cloud storage such as cloud object storage.
5. IaC deployment.

By way of example, a user or central IT management system 110 such as a build server may collect the files for a particular deploy and package them in relevant form in a file archive 130 such as a zip file or equivalent file format. The file archive 130 such as a zip file may then be placed in the selected object storage such as a local storage 132.

As mentioned, the user or central IT management system 110 may then trigger the cloud compute unit 150, e.g. by means of an API call. The API call thus works as a trigger for the cloud compute unit, which may then perform the following process:

i. Download/receive the file archive from the identified storage location (such as a local storage).
ii. Unpack or extract the file archive.
iii. Optionally, upload/transfer the unpacked files into cloud storage.
iv. Identify/find an IaC template in the file archive or among the unpacked files and initiate deployment of the IaC template. This may at least partly happen before ii and iii.

The cloud compute unit 150 may then deploy the IaC template from the file archive.

In the same way as described in connection with FIG. 1, the IaC stack 160 of FIG. 2 may be configured to create and maintain the cloud resources needed for a certain deploy. For more complex deploys, the IaC stack may be configured to create or invoke one or more resources, such as a well-accepted standard pipeline, that can carry out the rest of the actual deployment.

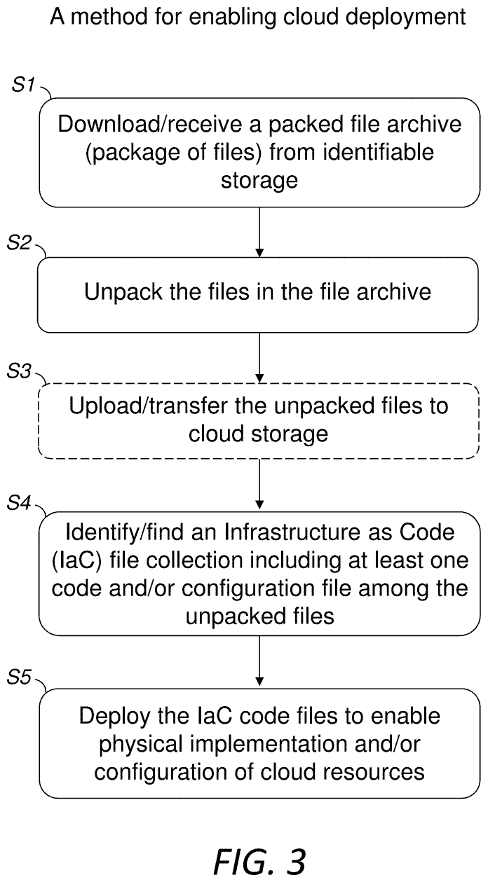

FIG. 3 is a schematic flow diagram illustrating an example of a method for enabling and/or performing cloud deployment.

According to a first aspect, there is provided a method for enabling and/or performing deployment of cloud resources. The method comprises:

Step S1: Downloading and/or receiving a package of files and/or a packed file archive including a number of files from an identifiable storage location.
Step S2: Unpacking the files.
Step S3: Optionally uploading and/or transferring the unpacked files to cloud storage.
Step S4: Identifying and/or finding an Infrastructure as Code (IaC) file collection, including one or more code and/or configuration files, in the file archive or among the unpacked files.
Step S5: Deploying the IaC code and/or configuration files to enable and/or effectuate physical implementation and/or configuration of cloud resources as specified by the IaC code and/or configuration files.

According to a second aspect, there is provided a cloud deployment system for deployment of cloud resources. The cloud deployment system is configured to download and/or receive a package of files such as a packed file archive including a number of files from an identifiable storage location, and to unpack the files. Optionally, the cloud deployment system may further be configured to upload and/or transfer the unpacked files to cloud storage. The cloud deployment system is also configured to identify and/or find an Infrastructure as Code (IaC) file collection, including one or more code and/or configuration files, in the file archive or among the unpacked files. The cloud deployment system is further configured to deploy the IaC code and/or configuration files to enable and/or effectuate physical implementation and/or configuration of cloud resources as specified by the IaC code and/or configuration files.

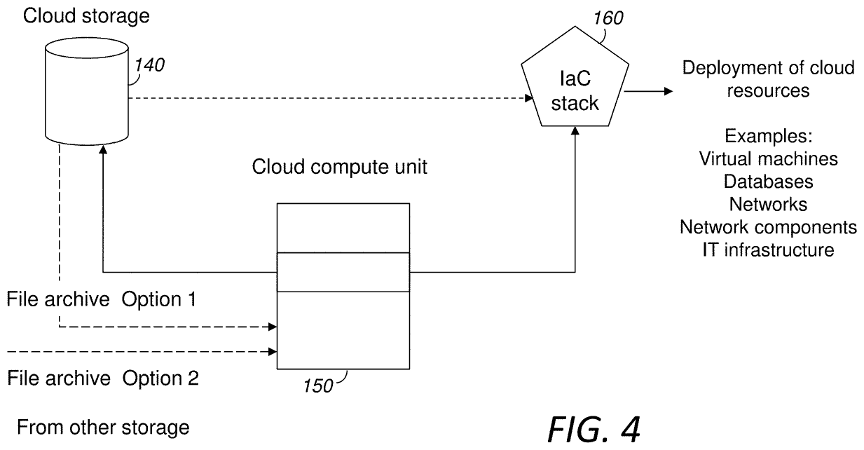

FIG. 4 is a schematic diagram illustrating an example of a cloud compute unit for enabling cloud deployment.

According to a third aspect, there is provided a cloud compute unit 150 configured to enable deployment of cloud resources. The cloud compute unit 150 is configured to download and/or receive a package of files such as a packed file archive including a number of code and/or configuration files from an identifiable storage location such as cloud storage 140 (Option 1) or another storage location (Option 2), e.g., located within the central IT management system 110 or any other suitable storage location. The cloud compute unit 150 is configured to unpack the files. Optionally, the cloud compute unit 150 may further be configured to upload and/or transfer the unpacked files to cloud storage 140. The cloud compute unit 150 is also configured to identify and/or find an IaC file collection (e.g. an IaC template), including one or more code and/or configuration files, in the file archive or among the unpacked files. Further, the cloud compute unit 150 is configured to deploy the IaC code and/or configuration files to enable and/or effectuate physical implementation and/or configuration of cloud resources as specified by the IaC code and/or configuration files.

For example, the deployment of the IaC file(s) results in the creation and/or update of an IaC stack 160 or equivalent state holder for holding the current states of the cloud deployment, and allowing the IaC stack to deploy any of a number of cloud resources such as virtual machines, databases, networks or sub-networks, network components such as gateways and routers, as well as other IT infrastructure.

By way of example, the deployment framework and/or process may also have the following optional components:
The ability to add a name, id and/or custom metadata (tags) in the file archive which greatly improves the possibility to track deploys and the code in it. This added information thus enables efficient tracking of a deploy and the associated code.
The ability to add configuration to the IaC template that the system deploys.
The ability to add any files to the file archive, thus they will be unpacked and placed in the cloud object storage. These files can be made available for predefined entities (systems or users). The files can thereafter be used to create any IT resources, e.g. the content for a website, code/binaries for an application, IaC templates, or configuration files etc.

In a specific and often preferred implementation, the system is made up of the following components: cloud compute and system code with a dependency on cloud object storage, cloud block storage, IaC template. The content in the file archive will be unpacked both to the cloud object storage and cloud block storage so that it can easily integrate with any cloud compute service without unnecessary file transfers.

The disclosed system is unique when compared with other known systems and solutions in that it provides a highly available and secure target (cloud object storage) that can easily interact with any client (entity that does the deploy).

Preferably, the cloud compute unit (with the system code) is configured to remain dormant until it's triggered by an event from the cloud object storage or an API call. It will then awaken and:

1. Unpack the files;
2. Identify the IaC template; and
3. Deploy the IaC template (creating or updating an IaC stack).

Because an IaC stack can generate any cloud resources, it is possible to deploy whole applications or other deployment resources that can act upon the other files in the file archive.

The disclosed software is unique in that the overall architecture of the system is different from other known systems. More specifically, it provides (1) a highly available and secure entry for deploy; (2) a highly fault tolerant system that can perform the deploys on demand; and (3) the system lays dormant when not being used so that its cheap to run and harder to hack (e.g. a cloud function that only exists for a few minutes are much harder to hack because the hacker have less time to perform the attack); and/or (4) the possibility to leverage any technology in the cloud via the flexibility of infrastructure as code.

It will be appreciated that the mechanisms and arrangements described herein can be implemented, combined and re-arranged in a variety of ways.

For example, embodiments may be implemented in hardware, or at least partly in software for execution by suitable processing circuitry, or a combination thereof.

The steps, functions, procedures, and/or blocks described herein may be implemented in hardware using any conventional technology, such as discrete circuit or integrated circuit technology, including both general-purpose electronic circuitry and application-specific circuitry.

Alternatively, or as a complement, at least some of the steps, functions, procedures, and/or blocks described herein may be implemented in software such as a computer program for execution by suitable processing circuitry such as one or more processors or processing units.

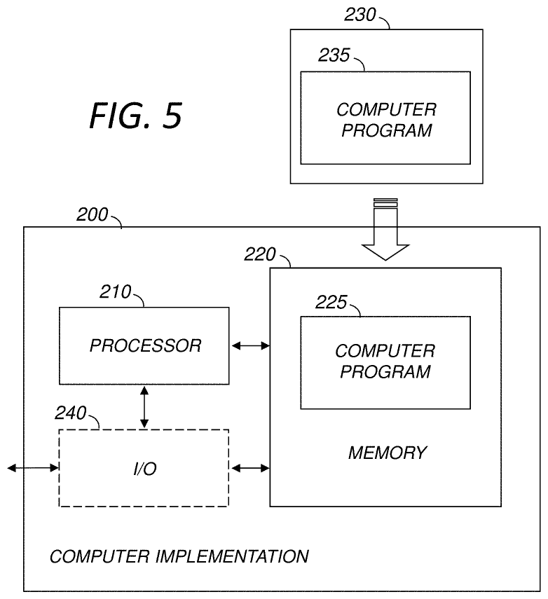

FIG. 5 is a schematic diagram illustrating an example of a computer implementation according to an embodiment. In this particular example, the system 200 comprises a processor 210 and a memory 220, the memory comprising instructions executable by the processor, whereby the processor is operative to perform the steps and/or actions described herein. The instructions are typically organized as a computer program 225; 235, which may be preconfigured in the memory 220 or downloaded from an external memory device 230. Optionally, the system 200 comprises an input/output interface 240 that may be interconnected to the processor(s) 210 and/or the memory 220 to enable input and/or output of relevant data such as input parameter(s) and/or resulting output parameter(s).

In a particular example, the memory comprises such a set of instructions executable by the processor, whereby the processor is operative to enable and/or effectuate deployment of cloud resources. In other words, the instructions, when executed by at least one processor, cause the processor(s) to perform the steps and/or functions described herein.

More particularly, the proposed technology provides a computer program for performing, when executed by a processor, the method for enabling and/or performing cloud deployment as described herein, as well as a corresponding computer-program product.

The term ‘processor’ should be interpreted in a general sense as any system or device capable of executing program code or computer program instructions to perform a particular processing, determining or computing task.

The processing circuitry including one or more processors is thus configured to perform, when executing the computer program, well-defined processing tasks such as those described herein.

The processing circuitry does not have to be dedicated to only execute the above-described steps, functions, procedure and/or blocks, but may also execute other tasks.

The proposed technology also provides a computer-program product comprising a non-volatile computer-readable storage medium 220; 230 having stored thereon such a computer program.

By way of example, the software or computer program 225; 235 may be realized as a computer program product, which is normally carried or stored on a computer-readable storage medium 220; 230, in particular a non-volatile medium. The computer-readable storage medium may include one or more removable or non-removable memory devices including, but not limited to a Read-Only Memory (ROM), a Random Access Memory (RAM), a Compact Disc (CD), a Digital Versatile Disc (DVD), a Blu-ray disc, a Universal Serial Bus (USB) memory, a Hard Disk Drive (HDD) storage device, a flash memory, a magnetic tape, or any other conventional memory device. The computer program may thus be loaded into the operating memory of a computer or equivalent processing device for execution by the processing circuitry thereof.

Method flows may be regarded as computer action flows, when performed by one or more processors. A corresponding device, system and/or apparatus may be defined as a group of function modules, where each step performed by the processor corresponds to a function module. In this case, the function modules are implemented as a computer program running on the processor. Hence, the device, system and/or apparatus may alternatively be defined as a group of function modules, where the function modules are implemented as a computer program running on at least one processor.

The computer program residing in memory may thus be organized as appropriate function modules configured to perform, when executed by the processor, at least part of the steps and/or tasks described herein.

Alternatively, it is possible to realize the modules predominantly by hardware modules, or alternatively by hardware. The extent of software versus hardware is purely implementation selection.

The embodiments described above are merely given as examples, and it should be understood that the proposed technology is not limited thereto. It will be understood by those skilled in the art that various modifications, combinations and changes may be made to the embodiments without departing from the present scope as defined by the appended claims. In particular, different part solutions in the different embodiments can be combined in other configurations, where technically possible.

1. A method for enabling and/or performing deployment of cloud resources, wherein the method comprises:
downloading and/or receiving a package of files and/or a packed file archive including a number of files from an identifiable storage location,
unpacking the files,
identifying and/or finding an Infrastructure as Code (IaC) file collection, including one or more code and/or configuration files, in the file archive or among the unpacked files; and
deploying the IaC code and/or configuration files to enable and/or effectuate physical implementation and/or configuration of cloud resources as specified by the IaC code and/or configuration files.

2. The method of claim 1, wherein said method further comprises uploading and/or transferring the unpacked files to cloud storage.

3. The method of claim 1, wherein said IaC file collection, including one or more code and/or configuration files, is represented by one or more files of an IaC template.

4. The method of claim 1, wherein the package of files and/or the packed file archive is and/or includes at least one of a zip, tar, pax and rar archive.

5. The method of claim 1, wherein the step of downloading and/or receiving a package of files and/or a packed file archive is triggered by placement of the package of files and/or the packed file archive in cloud storage.

6. The method of claim 1, wherein the step of downloading and/or receiving a package of files and/or a packed file archive is triggered by an Application Programming Interface (API) call with an indication or instructions on where to find the package of files and/or the packed file archive.

7. The method of claim 1, wherein the step of identifying and/or finding an Infrastructure as Code (IaC) file collection includes identifying and/or finding an indication of a location of the IaC file collection in the file archive or among the unpacked files.

8. The method of claim 1, wherein the package of files and/or the packed file archive is downloaded and/or received from a cloud storage or an alternative storage location that is accessible by a cloud compute unit.

9. The method of claim 1, wherein said step of deploying the IaC code and/or configuration files includes performing one or more standard IaC deployment procedures.

10. The method of claim 1, wherein deployment of the IaC file(s) is configured to create and/or update an IaC stack or equivalent state holder for holding the current states of the cloud deployment, allowing the IaC stack to deploy any of a number of cloud resources.

11. The method of claim 1, wherein said cloud resources include IaaS (Infrastructure as a Service), PaaS (Platform as a Service) and SaaS (Software as a Service) systems, components and/or services.

12. The method of claim 1, wherein said cloud resources include at least one of the following: IT infrastructure, networks or sub-networks, network components, gateways and routers, virtual machines, databases, and computing and/or processing resources.

13. The method of claim 1, wherein the method further comprises at least one of the following:
adding a name, id and/or custom metadata in the package of files and/or the file archive;
adding configuration to the IaC file collection;
adding at least one file to the package of files and/or the file archive so that they will be unpacked and placed in the cloud storage.

14. The method of claim 1, wherein the method is performed by a cloud compute unit.

15. A cloud deployment system configured for deployment of cloud resources,
wherein the cloud deployment system is configured to download and/or receive a package of files and/or a packed file archive including a number of files from an identifiable storage location, and to unpack the files;
wherein the cloud deployment system is also configured to identify and/or find an Infrastructure as Code (IaC) file collection, including one or more code and/or configuration files, in the file archive or among the unpacked files; and
wherein the cloud deployment system is further configured to deploy the IaC code and/or configuration files to enable and/or effectuate physical implementation and/or configuration of cloud resources as specified by the IaC code and/or configuration files.

16. The cloud deployment system of claim 15, wherein the cloud deployment system is further configured to upload and/or transfer the unpacked files to cloud storage.

17. The cloud deployment system of claim 15, wherein said IaC file collection, including one or more code and/or configuration files, is represented by one or more files of an IaC template.

18. The cloud deployment system of claim 15, wherein the package of files and/or the packed file archive is and/or includes at least one of a zip, tar, pax and rar archive.

19. The cloud deployment system of claim 15, wherein the cloud deployment system is configured to download and/or receive a package of files and/or a packed file archive in response to placement of the package of files and/or the packed file archive in cloud storage.

20. The cloud deployment system of claim 15, wherein the cloud deployment system is configured to download and/or receive a package of files and/or a packed file archive in response to an Application Programming Interface (API) call with an indication or instructions on where to find the package of files and/or the packed file archive.

21. The cloud deployment system of claim 15, wherein the cloud deployment system is configured to identify and/or find an Infrastructure as Code (IaC) file collection by at least partly identifying and/or finding an indication of a location of the IaC file collection in the file archive or among the unpacked files.

22. The cloud deployment system of claim 15, wherein the cloud deployment system is configured to download and/or receive the package of files and/or the packed file archive from a cloud storage or an alternative storage location that is accessible by a cloud compute unit.

23. The cloud deployment system of claim 15, wherein said cloud resources include at least one of the following: IT infrastructure, networks or sub-networks, network components, gateways and routers, virtual machines, databases, and computing and/or processing resources.

24. The cloud deployment system of claim 15, wherein the cloud deployment system includes at least one processor configured to perform and/or enable said deployment of cloud resources.

25. A cloud compute unit configured to enable deployment of cloud resources,
wherein the cloud compute unit is configured to download and/or receive a package of files and/or a packed file archive including a number of code and/or configuration files from an identifiable storage location;
wherein the cloud compute unit is configured to unpack the files;
wherein the cloud compute unit is also configured to identify and/or find an Infrastructure as Code (IaC) file collection, including one or more code and/or configuration files, in the file archive or among the unpacked files; and
wherein the cloud compute unit is configured to deploy the IaC code and/or configuration files to enable and/or effectuate physical implementation and/or configuration of cloud resources as specified by the IaC code and/or configuration files.

26. The cloud compute unit of claim 25, wherein the cloud compute unit is further configured to upload and/or transfer the unpacked files to cloud storage.

27. A computer-program product comprising a non-volatile computer-readable storage medium having stored thereon a computer program for performing, when executed by a processor, the method for enabling and/or performing cloud deployment according to claim 1.
